(19) United States
(12) Patent Application Publication
(10) Pub. No.: US 2026/0193097 A1
(43) Pub. Date: Jul. 9, 2026

(54) PRECURSOR OF CATHODE ACTIVE MATERIAL

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 19/401,912

(22) Filed: Nov. 26, 2025

(30) Foreign Application Priority Data
Jan. 9, 2025 (JP) 2025-003190

(51) Int. Cl. C01G 53/05

(52) U.S. Cl. CPC C01G 53/05; C01P 2002/74; C01P 2004/45; C01P 2004/51; C01P 2006/14; C01P 2006/40

(57) ABSTRACT

A precursor of a cathode active material includes secondary particles each including a plurality of primary particles aggregated together. The primary particles include a nickel composite hydroxide. In a pore size distribution (pore volume per unit weight versus pore size) as measured by mercury intrusion porosimetry, the precursor has two or more peaks each having a peak area percentage of 2% or more within a range in which the pore size is up to and including twice the average particle size D50 of the precursor, when the total pore volume in the range is defined as 100%.

### CROSS-REFERENCE TO RELATED APPLICATION

This application claims priority to Japanese Patent Application No. 2025-003190 filed on Jan. 9, 2025. The disclosure of the above-identified application, including the specification, drawings, and claims, is incorporated by reference herein in its entirety.

### BACKGROUND

### 1. Technical Field

The present disclosure relates to precursors of cathode active materials.

### 2. Description of Related Art

Various techniques have been proposed regarding cathode active materials such as those disclosed in Japanese Unexamined Patent Application Publication Nos. 2024-83946 (JP 2024-83946 A) and 2021-24764 (JP 2021-24764 A).

### SUMMARY

Conventionally, various cathode active materials have been proposed in order to obtain a cathode having excellent battery characteristics such as high cycle characteristics and high output characteristics.

For example, JP 2024-83946 A describes a precursor of a cathode active material for a lithium-ion secondary battery. This precursor is composed of a lithium metal composite hydroxide including secondary particles formed by aggregation of primary particles. JP 2024-83946 A describes that, by forming a shell portion with high particle strength around a core portion having a particle structure such as a high-porosity structure, a hollow structure, or a porous structure, a cathode active material for a lithium-ion secondary battery can be obtained that maintains good battery characteristics while also exhibiting high particle strength.

The cathode active material obtained by mixing the precursor described in Japanese Patent Application Publication No. 2024-83946 with a lithium source and calcining the mixture may exhibit high resistance. This is because the surface area of the cathode active material that directly contributes to the battery reaction is insufficient, or because, during the calcination, a sufficient amount of lithium may not be incorporated into the cathode active material, resulting in a lithium deficiency. A cathode active material with high resistance causes deterioration in the output characteristics of the secondary battery. Accordingly, a cathode active material with low resistance is desired.

The present disclosure has been made in view of the above circumstances, and a main object thereof is to provide a precursor of a cathode active material that can produce a cathode active material with low resistance.

The present disclosure includes the following aspects.

(1) A precursor of a cathode active material, the precursor including
secondary particles each including a plurality of primary particles aggregated together,
wherein:
the primary particles include a nickel composite hydroxide; and
in a pore size distribution that is a relationship of the pore volume per unit weight versus the pore size as measured by mercury intrusion porosimetry, the precursor has two or more peaks each having a peak area percentage of 2% or more within a range in which the pore size is up to and including twice the average particle size D50 of the precursor, when the total pore volume in the range is defined as 100%.

(2) The precursor according to (1), wherein, in the range of the pore size distribution, the ratio of a second pore size of a second peak having the second largest peak area to a first pore size of a first peak having the largest peak area (second pore size/first pore size) is 1.6 or more.

(3) The precursor according to (1) or (2), wherein, in the range of the pore size distribution, the ratio of a second pore size of a second peak having the second largest peak area to a first pore size of a first peak having the largest peak area (second pore size/first pore size) is 1.6 or more and 11.4 or less.

(4) The precursor according to any one of (1) to (3), wherein the nickel composite hydroxide is a nickel-cobalt-manganese composite hydroxide.

The present disclosure can provide a precursor of a cathode active material that can produce a cathode active material with low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of the structure of a precursor according to the present disclosure.

### DETAILED DESCRIPTION OF EMBODIMENTS

An embodiment according to the present disclosure will now be described. It should be noted that matters not specifically mentioned in the present specification but necessary to carry out the present disclosure (for example, general configurations and production processes of a cathode active material and its precursor that are not characteristic of the present disclosure) may be understood as design matters for those skilled in the art based on conventional techniques in the art. The present disclosure may be carried out based on the content disclosed in the present specification and the common general technical knowledge in the art.

The dimensional relationships (such as length, width, and thickness) shown in the drawings do not reflect the actual dimensional relationships.

The present disclosure provides a precursor of a cathode active material. The precursor includes secondary particles each including a plurality of primary particles aggregated together. The primary particles include a nickel composite hydroxide. In a pore size distribution (pore volume per unit weight versus pore size) as measured by mercury intrusion porosimetry, the precursor has two or more peaks each having a peak area percentage of 2% or more within a range in which the pore size is up to and including twice the average particle size D50 of the precursor, when the total pore volume in the range is defined as 100%.

The method for counting the number of peaks in the pore distribution according to the present disclosure will be described.

In the present disclosure, from the pore distribution (pore volume per unit weight versus pore size) of the precursor as measured by mercury intrusion porosimetry, data in the range of pore sizes up to and including twice the average particle size D50 of the precursor is used. Specifically, the vertical axis represents pore volume per unit weight and the horizontal axis represents pore size, with the horizontal axis being limited to a range of pore sizes up to and including twice the average particle size D50 of the precursor. Peaks in a range exceeding twice the average particle size D50 are not considered.
The average particle size D50 of the precursor refers to the median diameter at which the cumulative value of a volume-based particle size distribution reaches 50%, and may be measured by dynamic light scattering. The average particle size D50 may also be calculated by laser diffraction scattering, electrical sensing zone method, cross-sectional image analysis using a scanning electron microscope (SEM), or cross-sectional image analysis using a transmission electron microscope (TEM).

Next, in the pore distribution within the above range, a range up to the point where the slope of the distribution changes from negative to positive is recognized as one peak.

For each recognized peak, the peak area, i.e., the sum of the Y-coordinate values of the peak, is calculated.
Then, when the total pore volume within the above range, that is, the sum of all Y-coordinate values within the above range, is defined as 100%, a peak having a calculated peak area percentage of 2% or more is counted as one peak. Peaks having a calculated peak area percentage of less than 2% are not counted. The peak area percentage (%) of each peak can be calculated by the following equation:

Peak area percentage(%)=sum of Y-coordinate values of each peak/sum of all Y-coordinate values×100

Any known method may be used to measure the pore size distribution by mercury intrusion porosimetry, and a mercury porosimeter may be used. Any known method may also be used to calculate the average pore size from the pore size distribution measured by mercury intrusion porosimetry.

A precursor having coarse spaces between secondary particles and inside the secondary particles (between primary particles) tends to exhibit two or more peaks in the pore distribution measured by mercury intrusion porosimetry. Since the precursor of the present disclosure has two or more peaks in the pore distribution, it is considered to have a coarse structure.

A precursor having such a coarse structure can produce an active material having a high specific surface area. Since the precursor has a coarse structure, when a metal source such as a lithium source is mixed with the precursor and calcined to synthesize an active material, the metal derived from the metal source readily penetrates into the precursor, and therefore the reaction between the metal source and the nickel composite hydroxide proceeds smoothly. As a result, it becomes possible to synthesize an active material with fewer defects, in which metals derived from the metal source such as lithium are sufficiently incorporated into the crystal structure. An active material with many defects due to a deficiency of metals serving as mobile ions exhibits high resistance. Accordingly, the present disclosure makes it possible to obtain an active material with low resistance. That is, according to the present disclosure, the output characteristics of a battery can be improved.

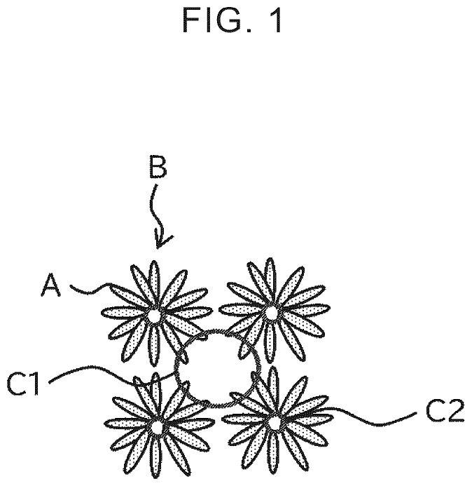

FIG. 1 is a conceptual diagram illustrating an example of the structure of the precursor according to the present disclosure. The precursor of the present disclosure includes secondary particles B each including a plurality of primary particles A aggregated together as shown in FIG. 1. In addition to the secondary particles, the precursor of the present disclosure may also include primary particles existing individually without aggregation.

The precursor of the present disclosure has two or more peaks in the pore size distribution. Accordingly, as shown in FIG. 1, the precursor of the present disclosure includes not only pores C1 between secondary particles B but also pores C2 inside the secondary particles B (between primary particles A), and thus has a coarse structure.

In the above range of the pore size distribution measured by mercury intrusion porosimetry (the range in which the pore size is up to and including twice the average particle size D50 of the precursor), a peak having the largest peak area is defined as a first peak, and the pore size of the first peak is defined as a first pore size. A peak having the second largest peak area is defined as a second peak, and the pore size of the second peak is defined as a second pore size. In this case, from the viewpoint of obtaining a low-resistance active material, the ratio of the second pore size to the first pore size (second pore size/first pore size) may be 1.6 or more in the precursor of the present disclosure. The ratio of the second pore size to the first pore size (second pore size/first pore size) may be 1.6 or more and 11.4 or less, or may be 1.8 or more and 11.4 or less.

The first peak is the peak having the largest peak area percentage among two or more peaks, as calculated by the above method for counting the number of peaks, and the second peak is the peak having the second largest peak area percentage after the first peak. The first pore size, which is the pore size of the first peak, refers to the pore size at which the pore volume per unit weight becomes maximum in the first peak. Similarly, the second pore size, which is the pore size of the second peak, refers to the pore size at which the pore volume per unit weight becomes maximum in the second peak. Even when there are three or more peaks, it is sufficient to calculate the ratio of the pore sizes of the two peaks having the largest peak area ratios.

In the present disclosure, the primary particles include a nickel composite hydroxide. The nickel composite hydroxide is a hydroxide containing nickel (Ni) and another metal species other than nickel. The other metal species other than nickel may be of one kind or two or more kinds. Examples of the other metal species other than nickel include manganese (Mn), cobalt (Co), and aluminum (Al). Specific examples of nickel composite hydroxides include a nickel-cobalt composite hydroxide containing nickel and cobalt, a nickel-cobalt-manganese composite hydroxide containing nickel, cobalt, and manganese, and a nickel-cobalt-aluminum composite hydroxide containing nickel, cobalt, and aluminum. The nickel composite hydroxide may be a nickel-cobalt-manganese composite hydroxide.

In these nickel composite hydroxides, the ratios (molar ratios) of nickel and the other metal species to the total amount of nickel and the other metal species are not particularly limited. In the case of a nickel-cobalt composite hydroxide, the molar ratios may be as follows. Ni/NiCo may be 0.5 or more and 1.0 or less, and Co/NiCo may be 0 or more and 0.5 or less. In the case of a nickel-cobalt-manganese composite hydroxide, the molar ratios may be as follows. Ni/NiCoMn may be 0.5 or more and 1.0 or less, Co/NiCoMn may be 0 or more and 0.3 or less, and Mn/NiCoMn may be 0 or more and 0.3 or less. In the case of a nickel-cobalt-aluminum composite hydroxide, the molar ratios may be as follows. Ni/NiCoAl may be 0.5 or more and 1.0 or less, Co/NiCoAl may be 0 or more and 0.3 or less, and Al/NiCoAl may be 0 or more and 0.3 or less.

In the present disclosure, the nickel composite hydroxide may further contain another metal species other than nickel, cobalt, aluminum, and manganese. The other metal species may include at least one selected from the group consisting of, for example, Zr, Mo, Mg, Ca, Na, Fe, Cr, Zn, Si, Sn, and Ag.

The size of the primary particles is not particularly limited. For example, when the particles have a flat shape such as a plate or needle shape, the average value of the length in the short-side direction (thickness) may be from 10 nm to 200 nm. The size of the primary particles can be determined by, for example, measuring the thicknesses of cross sections of a plurality of primary particles in TEM images or SEM images and calculating the average value thereof.

The size of the secondary particle formed by aggregation of a plurality of such primary particles is not particularly limited. For example, the average particle size of the secondary particles may be from 4 μm to 15 μm, or may be from 4 μm to 10 μm. As in the case of the primary particles, the average particle size of the secondary particles can be determined by measuring the particle sizes of a plurality of secondary particles in TEM observation or SEM observation and calculating the average value thereof.

The method for producing the precursor of the cathode active material of the present disclosure is not particularly limited, and examples include the following method. First, a water-soluble nickel source (nickel compound) serving as a starting material of the nickel composite hydroxide, and another water-soluble metal source (such as a cobalt compound, a manganese compound, or an aluminum compound) are dissolved in deionized water to prepare an aqueous metal source solution. At this time, in the aqueous metal source solution, the ratios (mol %) of nickel and the other metal species to the total amount of nickel and the other metal species are typically adjusted to be equal to the ratios (mol %) of nickel and the other metal species in the nickel composite hydroxide to be formed. The water-soluble metal compounds are not particularly limited, and examples include sulfates. The concentration of the aqueous metal source solution is not particularly limited, and may be, for example, such a concentration that the total concentration of metal species (the proportion of all the metal sources in the aqueous metal source solution) is 0.8 mol/L. Next, a certain amount of aqueous NH₃ solution (ammonium ion donor) is placed in a reaction vessel, and while stirring with a stirrer etc., the atmosphere is purged with nitrogen to create a non-oxidizing atmosphere. The concentration of the aqueous NH₃ solution may be, for example, 30 g/L to 40 g/L.

Subsequently, an aqueous sodium hydroxide solution is added to the reaction vessel, and while maintaining the pH in the alkaline range (e.g., pH 10.8 to pH 12.5), the aqueous metal source solution and the aqueous NH₃ solution are added dropwise into the reaction vessel. The pH may be controlled such that the pH at the end of dropwise addition of the aqueous metal source solution and the aqueous NH₃ solution is lower than the pH at the start of dropwise addition. For example, the pH at the start of dropwise addition of the aqueous metal source solution and the aqueous NH₃ solution may be 11.5 to 12.5, and the pH at the end of dropwise addition may be 10.8 to 11.0. The concentration of the aqueous NH₃ solution may be, for example, 30 g/L to 40 g/L. The reaction temperature is not particularly limited. After completion of the reaction, a drying treatment is performed. For example, the drying treatment may be carried out at 110° C. for 10 hours under an inert gas atmosphere.

The precursor of the cathode active material of the present disclosure can be used as, for example, a cathode active material for a battery such as a lithium-ion battery by being converted into a lithium-nickel composite oxide.

The lithium-nickel composite oxide can be produced from the precursor of the present disclosure by, for example, the following method. The nickel composite hydroxide that is the precursor of the present disclosure is mixed with a lithium compound serving as a lithium source, and the obtained mixture is calcined.

The lithium compound may be, for example, at least one selected from lithium carbonate, lithium nitrate, lithium acetate, lithium hydroxide, lithium oxide, and lithium chloride.

The ratio of the lithium compound to the precursor in the mixture is typically adjusted such that the ratios (mol %) of lithium and the other metal species to the total amount of lithium and the other metal species in the target cathode active material becomes equal to the ratios (mol %) of lithium and the other metal species in the mixture. The mixing method is not particularly limited, and any known method may be used.

The obtained mixture is calcined, for example, at 700° C. to 950° C. for eight hours to 15 hours under an oxygen atmosphere. A lithium-nickel composite oxide can thus be obtained. Known calcination furnaces such as a muffle furnace can be used for the calcination.

The cathode active material obtained by calcining the precursor of the present disclosure is generally considered to be composed of single-crystal particles.
As used herein, the “single-crystal particle” refers to a single particle that does not form a secondary particle and that is substantially composed of a single crystal. Whether the particles are single-crystal particles can be confirmed by the absence of grain boundaries in an SEM image.

The precursor of the cathode active material provided by the present disclosure can be used as, for example, a precursor of a cathode active material constituting the cathode of a battery (such as a lithium-ion battery). That is, the present disclosure can provide a battery in which a cathode, an electrolyte layer, and an anode are stacked in this order and the cathode contains a cathode active material obtained from the precursor of the present disclosure. The battery will now be described.

The cathode includes a cathode layer, and may further include a cathode current collector.

The cathode layer is a layer containing at least a cathode active material. The cathode active material may solely contain the cathode active material obtained from the precursor of the present disclosure, or may further contain another active material. The content of the cathode active material in the cathode layer is not particularly limited, and may be, for example, from 20 mass % to 80 mass %.
The cathode layer may further contain at least one of the following: an electrolyte, an electrically conductive material, and a binder.
Examples of electrolytes include solid electrolytes. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte. The proportion of the solid electrolyte in the cathode layer may be, for example, from 10 mass % to 60 mass %.
Examples of electrically conductive materials include carbon materials, metal particles, and electrically conductive polymers. Examples of carbon materials include particulate carbon materials such as acetylene black (AB) and Ketjen black (KB), and fibrous carbon materials such as vapor-grown carbon fibers (VGCFs), carbon nanotubes (CNTs), and carbon nanofibers (CNFs). The proportion of the electrically conductive material in the cathode layer may be, for example, from 0.1 mass % to 5 mass %.
Examples of binders include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymers (SISs), and ethylene-propylene-diene copolymers (EPDMs). The proportion of the binder in the cathode layer may be, for example, from 0.5 mass % to 5 mass %.

Examples of materials for the cathode current collector include SUS, Cr, Au, Pt, Zn, aluminum, copper, nickel, iron, titanium, and carbon. The thickness of the cathode current collector is, for example, 0.1 μm or more and 100 μm or less. The cathode current collector may be in the form of a foil or a plate. The shape of the cathode current collector as viewed in plan is not particularly limited, and examples include circular, elliptical, rectangular, and any polygonal shapes. The cathode current collector may have a structure in which a buffer layer, an elastic layer, or a positive temperature coefficient (PTC) thermistor layer is provided on its surface.

The anode includes an anode layer, and may further include an anode current collector.

The anode layer is a layer containing at least an anode active material. The anode layer may further contain at least one of the following: an electrolyte, an electrically conductive material, and a binder. Examples of anode active materials for lithium-ion batteries include carbon materials such as natural graphite, lithium metal, and lithium alloys.
The electrolyte, electrically conductive material, and binder used in the anode layer may be the same as those described above for the cathode layer.
Examples of materials for the anode current collector include SUS, aluminum, copper, nickel, iron, titanium, and carbon. The thickness of the anode current collector is, for example, 0.1 μm or more and 100 μm or less. The anode current collector may be in the form of a foil or a plate. The shape of the anode current collector as viewed in plan is not particularly limited, and examples include circular, elliptical, rectangular, and any polygonal shapes. The anode current collector may have a structure in which a buffer layer, an elastic layer, or a PTC thermistor layer is provided on its surface.

The electrolyte layer is a layer formed between the cathode layer and the anode layer and contains at least an electrolyte. Examples of electrolytes include electrolyte solutions in addition to the solid electrolytes described above for the cathode layer.

The electrolyte solution may be an aqueous electrolyte solution or a non-aqueous electrolyte solution. One kind of electrolyte solution may be used alone, or two or more kinds of electrolyte solutions may be used in combination.

The solvent of the aqueous electrolyte solution contains water as a main component. That is, based on the total amount (100 mol %) of the solvent (liquid component) constituting the electrolyte solution, the proportion of water may be 50 mol % or more, particularly 70 mol % or more, and more particularly 90 mol % or more. There is no particular upper limit to the proportion of water in the solvent.

Although the solvent contains water as a main component, it may also contain a solvent other than water. The solvent other than water is, for example, one or more selected from ethers, carbonates, nitriles, alcohols, ketones, amines, amides, sulfur compounds, and hydrocarbons. Based on the total amount (100 mol %) of the solvent (liquid component) constituting the electrolyte solution, the proportion of solvents other than water may be 50 mol % or less, particularly 30 mol % or less, and more particularly 10 mol % or less.

The aqueous electrolyte solution contains an electrolyte. A conventionally known electrolyte may be used as the electrolyte for the aqueous electrolyte solution. Examples of electrolytes include lithium salts of imide compounds, lithium nitrates, lithium acetates, and lithium sulfates. Specific examples of electrolytes include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane)sulfonyl]butanesulfonylamide, lithium N,N-hexafluoro-1,3-disulfonylimide, CH₃COOLi, LiPF₆, LiBF₄, Li₂SO₄, and LiNO₃.

The concentration of the electrolyte in the aqueous electrolyte solution can be set as appropriate within a range that does not exceed the saturation concentration of the electrolyte in the solvent, according to the desired battery characteristics. This is because, if a solid electrolyte remains in an aqueous electrolyte solution, the solid may inhibit the battery reaction.

For example, when LiTFSI is used as the electrolyte, the aqueous electrolyte solution may contain 1 mol or more, particularly 5 mol or more, and more particularly 7.5 mol or more, of LiTFSI per 1 kg of the water. There is no particular upper limit to the concentration of the electrolyte. For example, the concentration of the electrolyte may be 25 mol or less.

An electrolyte solution containing a lithium salt and a non-aqueous solvent is usually used as a non-aqueous electrolyte solution.

Examples of lithium salts include inorganic lithium salts such as LiPF₆, LiBF₄, LiClO₄, and LiAsF₆, and organic lithium salts such as LiCF₃SO₃, LiN(SO₂CF₃)₂(Li-TFSI), LiN(SO₂C₂F₅)₂, and LiC(SO₂CF₃)₃.
Examples of non-aqueous solvents include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyl tetrahydrofuran, dimethyl sulfoxide (DMSO), and mixtures thereof. From the standpoint of ensuring high dielectric constant and low viscosity, the non-aqueous solvent may be a mixture of a cyclic carbonate compound having a high dielectric constant and high viscosity such as EC, PC, or BC and a chain carbonate compound having a low dielectric constant and low viscosity such as DMC, DEC, or EMC, or may be a mixture of EC and DEC.
The concentration of the lithium salt in the non-aqueous electrolyte solution may be, for example, from 0.3 M to 5 M.

The non-aqueous electrolyte solution may include an ionic liquid. The ionic liquid may include at least one selected from the group consisting of sulfonium salts, ammonium salts, pyridinium salts, piperidinium salts, pyrrolidinium salts, morpholinium salts, phosphonium salts, imidazolium salts, and derivatives thereof.

The electrolyte layer may include a separator impregnated with the above electrolyte solution and configured to isolate the cathode layer from the anode layer. The material of the separator is not particularly limited as long as it is a porous membrane, and examples include resins such as polyethylene (PE), polypropylene (PP), polyester, polyvinyl alcohol, cellulose, and polyamide. Among these, polyethylene and polypropylene may be used. The separator may have a single-layer structure or a multilayer structure. Examples of separators having a multi-layer structure include a separator having a two-layer structure of PE/PP, and a separator having a three-layer structure of PP/PE/PP or PE/PP/PE. The separator may be a nonwoven fabric such as a resin nonwoven fabric or a glass fiber nonwoven fabric.

The battery may further include a restraining jig that applies a restraining pressure along the thickness direction to the cathode layer, the electrolyte layer, and the anode layer. The restraining pressure may be, for example, from 0.1 MPa to 100 MPa.

The type of the battery is not particularly limited, and is generally a battery in which metal ions conduct between the cathode layer and the anode layer. Examples of such a battery include a lithium-ion battery. The battery may be either a primary battery or a secondary battery, but may particularly be a secondary battery. This is because it can be repeatedly charged and discharged and is useful, for example, as an in-vehicle battery.
The shape of the battery is not particularly limited. For example, the battery may be a coin battery, a cylindrical battery, a prismatic battery, a sheet battery, a button battery, a flat battery, or a laminated battery.

Examples of applications of the battery include power supplies for vehicles such as hybrid electric vehicles (HEVs), plug-in hybrid electric vehicles (PHEVs), battery electric vehicles (BEVs), gasoline vehicles, and diesel vehicles. In particular, the battery may be used as a drive power supply for hybrid electric vehicles (HEVs), plug-in hybrid electric vehicles (PHEV), or battery electric vehicles (BEVs). The battery may also be used as a power supply for moving objects other than vehicles (for example, trains, ships, and aircraft), or as a power supply for electrical products such as information processing devices.

### Examples 1 to 4 and Comparative Example 1

### Synthesis of Precursor of Cathode Active Material

NiSO₄, CoSO₄, and MnSO₄ were dissolved in deionized water to prepare an aqueous metal source solution. The Ni/Co/Mn ratio in the aqueous metal source solution was set to 80/10/10 in mol %. The total concentration of Ni, Co, and Mn in the aqueous metal source solution (the proportion of all the metal sources in the aqueous metal source solution) was set as shown in Table 1.

A certain amount of NH₃ aqueous solution was placed in a reaction vessel, and while stirring with a stirrer, the inside of the reaction vessel was purged with nitrogen. An aqueous NaOH solution was then added to the reaction vessel, and while maintaining the pH at an alkaline level, the aqueous metal source solution and the aqueous NH₃ solution were added dropwise into the reaction vessel. The pH of the reaction solution is shown in Table 1. The NH₃ concentration of the aqueous NH₃ solution is also shown in Table 1. As shown in Table 1, in Examples 1 to 4, the pH was controlled such that the pH at the end of dropwise addition was lower than that at the start of dropwise addition.
After completion of the reaction, a drying treatment was carried out at 110° C. for 10 hours under an inert gas atmosphere.

TABLE 1

| | Concentration of | pH at the | pH at the | |
|---|---|---|---|---|
| | Aqueous Metal | Start of | End of | NH₃ |
| | Source Solution | Dropwise | Dropwise | Concentration |
| | (mol/L) | Addition | Addition | (g/L) |
| Example 1 | 0.8 | 12.5 | 10.8 | 40 |
| Example 2 | 0.8 | 12.0 | 11.0 | 30 |
| Example 3 | 0.8 | 12.5 | 11.0 | 40 |
| Example 4 | 0.8 | 11.5 | 11.0 | 30 |
| Comparative | 1.5 | 11.0 | 11.0 | 20 |
| Example 1 | | | | |

For the obtained precursors of Examples 1 to 4 and Comparative Example 1, pore distribution measurement was performed by mercury intrusion porosimetry using a mercury porosimeter. Table 2 shows the number of peaks and the ratio of the second pore size to the first pore size for each precursor. The results of Comparative Example 1 in Tables 1 and 2 show that, in the synthesis of the precursor of the cathode active material, when the pH is maintained at 11.0 from the start to the end of dropwise addition of the aqueous metal source solution and the aqueous NH₃ solution, the number of peaks in the pore size distribution measured by mercury intrusion porosimetry can be controlled to one. The results of Examples 1 to 4 in Tables 1 and 2 show that, in the synthesis of the precursor of the cathode active material, when the pH is controlled such that the pH at the end of dropwise addition of the aqueous metal source solution and the aqueous NH₃ solution is lower than the pH at the start of dropwise addition, the number of peaks in the pore size distribution measured by mercury intrusion porosimetry can be controlled to two or more.

### Synthesis of Cathode Active Material

Each of the precursors of Examples 1 to 4 and Comparative Example 1 synthesized as described above and a lithium compound (LiOH) serving as a lithium source were mixed in a mortar. Each of the resulting mixtures was calcined in a calcination furnace at 750° C. for 10 hours under an oxygen atmosphere to synthesize cathode active materials (LiNi_{0.8}Co_{0.1}Mn_{0.1}O₂) of Examples 1 to 4 and Comparative Example 1.

### Cell Fabrication

Small laminate cells of Examples 1 to 4 and Comparative Example 1 were fabricated using the cathode active materials of Examples 1 to 4 and Comparative Example 1, respectively.

Specifically, a cathode composite paste containing the cathode active material and acetylene black as an electrically conductive material was applied to the surface of a metal foil serving as a cathode current collector using a film applicator with a thickness adjustment function (manufactured by Allgood Co., Ltd.). The coating was then dried at 80° C. for five minutes in a dryer to prepare a cathode having a cathode layer on the cathode current collector.
Meanwhile, an anode composite paste containing natural graphite as an anode active material was applied to the surface of a metal foil serving as an anode current collector using a film applicator with a thickness adjustment function (manufactured by Allgood Co., Ltd.). The coating was then dried at 80° C. for five minutes in a dryer to prepare an anode having an anode layer on the anode current collector.
A 1 M LiPF₆ solution containing LiPF₆ as an electrolyte and ethylene carbonate (EC), dimethyl carbonate (DMC), and ethyl methyl carbonate (EMC) as a solvent in a volume ratio of EC/DMC/EMC=3/4/3 vol % was prepared as an electrolyte solution.
The cathode, a separator, and the anode were stacked, and the separator was impregnated with the electrolyte solution. The small laminate cells of Examples 1 to 4 and Comparative Example 1 were thus fabricated.

### Cell Evaluation

The resistance of each of the fabricated small laminate cells was measured under the following conditions.

### Resistance Measurement Conditions

C-rate: 0.5 C, 1 C, 1.5 C
Discharge time mode: 10 seconds
Temperature: 25° C.

At each C-rate, current and voltage during discharge were plotted, and the slope of a straight line obtained by linear fitting was calculated as the resistance value. The resistance value of Comparative Example 1 was used as a reference, and the resistance values of Examples 1 to 4 were normalized using the following equation.

$$Normalized resistance = ( resistance value of each Example ) / \\ ( resistance value of Comparative Example 1 )$$

The results are shown in Table 2.

TABLE 2

| | Number | Second Pore | |
|---|---|---|---|
| | of | Size/First | Normalized |
| | Peaks | Pore Size | Resistance |
| Example 1 | 2 | 11.4 | 0.76 |
| Example 2 | 3 | 1.8 | 0.82 |
| Example 3 | 2 | 3.5 | 0.80 |
| Example 4 | 2 | 1.6 | 0.91 |
| Comparative Example 1 | 1 | — | 1.00 |

As shown in Table 2, compared with Comparative Example 1 in which the number of peaks in the pore size distribution measured by mercury intrusion porosimetry was one, Examples 1 to 4, in which the number of peaks was two or more, were all confirmed to have low resistance. In Examples 1 to 4, the value of the ratio of the second pore size to the first pore size was 1.6 or more and 11.4 or less. Among Examples 1 to 4, Examples 1 to 3, in which the value of the ratio of the second pore size to the first pore size was 1.8 or more and 11.4 or less, exhibited particularly low resistance values.

What is claimed is:

1. A precursor of a cathode active material, the precursor comprising
secondary particles each including a plurality of primary particles aggregated together, wherein:
the primary particles include a nickel composite hydroxide; and
in a pore size distribution that is a relationship of a pore volume per unit weight versus a pore size as measured by mercury intrusion porosimetry, the precursor has two or more peaks each having a peak area percentage of 2% or more within a range in which the pore size is up to and including twice an average particle size D50 of the precursor, when a total pore volume in the range is defined as 100%.

2. The precursor according to claim 1, wherein, in the range of the pore size distribution, a ratio of a second pore size of a second peak having a second largest peak area to a first pore size of a first peak having a largest peak area is 1.6 or more.

3. The precursor according to claim 1, wherein, in the range of the pore size distribution, a ratio of a second pore size of a second peak having a second largest peak area to a first pore size of a first peak having a largest peak area is 1.6 or more and 11.4 or less.

4. The precursor according to claim 1, wherein the nickel composite hydroxide is a nickel-cobalt-manganese composite hydroxide.
